(19) United States
(12) Patent Application Publication
(10) Pub. No.: US 2016/0350805 A1
(43) Pub. Date: Dec. 1, 2016

(54) SYSTEM AND METHOD FOR TRACKING CAR SALES

(71) Applicant: Catalyst Trade C/O Jeffrey Tognetti, Key Biscanye, FL (US)

(72) Inventor: Jeffrey TOGNETTI, Key Biscayne, FL (US)

(73) Assignee: Catalyst Trade C/O Jeffrey Tognetti, Key Biscanye, FL (US)

(21) Appl. No.: 15/232,198

(22) Filed: Aug. 9, 2016

Related U.S. Application Data
(63) Continuation of application No. 15/158,882, filed on May 19, 2016, now abandoned.
Application No. 15/158,882 is a continuation of application No. 14/527,021, filed on Oct. 29, 2014.

(51) Int. Cl. G06Q 30/02; G06F 17/30

(52) U.S. Cl. CPC G06Q 30/0255; G06F 17/30867

(57) ABSTRACT

A system and method for tracking car sales by a car seller. After selling a car to a car purchaser personal identifying information is obtained from the car purchaser. The personal identifying information may be exported to an onboarding module which attempts to match the personal identifying information to identifying information assigned to an active user of third party website. Electronic identifying information of the active user received from the third party website may be matched to the car purchaser. The electronic identifying information may then be matched to an electronic identifier stored by the car seller of a viewer of car advertisements to determine an advertisement viewing history of the car purchaser.

FIELD

The disclosed technology relates generally to methods for tracking car sales and, more specifically, to methods for tracking advertisements leading to car sales by a car seller.

### BACKGROUND

Many sellers, and particularly car sellers, spend large sums of money on advertising, typically via more than one advertising avenue. In order to determine which advertising avenues are most effective, and thus where money should be spent, sellers often wish to know which advertisement was seen by a buyer, and may have influenced a buyer to make a purchase.

The old-fashioned way of finding out what caused a buyer to purchase a product from a seller, is to simply ask the buyer, either at the time of purchase or in a follow-up communication, such as in a follow-up telephone call or e-mail message. However, this method may not be effective if buyers does not remember where they saw the advertisement, was not consciously aware that they saw an advertisement, do not wish to tell where they saw the advertisement, or lie about where they saw the advertisement.

Thus, numerous methods have been developed for identifying where the buyer may have seen an advertisement for the sold product, without requiring direct input from the buyer. Such methods are disclosed, for example, in U.S. Pat. No. 8,706,551, in U.S. Patent Application Publication No. 2011/0307385, and in U.S. Patent Application Publication No. 2009/0216579. However, none of these methods relate specifically to tracking car sales from a car seller, or that the tracking is accomplished by way of an email targeting a car buyer or by way of matching received data to an internet protocol address and other data stored in a tangible storage medium associated with the internet protocol address and with cookies of the car buyer.

Therefore, it is an object of the disclosed technology to provide a method and a device for tracking car sales from a car seller, by sending email targeting car buyers and/or by matching data received from car buyers to an internet protocol address and other data stored in a tangible storage medium associated with the internet protocol address and with cookies of the car buyer.

### SUMMARY

The disclosed technology described herein addresses a need unfulfilled in the prior art by providing a method and a device for tracking car sales by a car seller, and specifically for electronically identifying an advertisement seen by a car buyer prior to the buyer buying a car from the car seller, without requiring direct input from the car buyer.

In accordance with some aspects of an embodiment of the teachings herein there is provided a method for tracking car sales by a car seller, the method comprising selling a car to a car purchaser and obtaining from the car purchaser personal identifying information, including at least an email address, sending an email to the car purchaser via a network node, using the email address as an identifier, wherein the email comprises data viewable only by downloading the data from a hardware server associated with the car seller, and after a purchase of the car, attempting to identify data viewed by the purchaser of the car before the purchase thereof, the viewed data sent and received via a packet switched network comprising a plurality of hardware switches and hardware routers, the attempting including each of including a tracking pixel in the email sent to the car purchaser, thereby to obtain at least one of an internet protocol (IP) address and cookie ID of the car purchaser, retrieving an IP address of a viewer of at least one first car advertisement, an identity of the viewer unknown to the car seller, retrieving cookie data stored on a hardware storage device of at least one viewer of at least one second car advertisement, an identity of the viewer unknown to the car seller, determining, based on matches of identifying data including at least one of email address, IP address, and cookie ID which advertisements were viewed by the car purchaser and storing the matches in a tangible storage medium, and determining, based on the matched identifying data, an advertisement viewing history of the car purchaser and which advertisement ultimately led to purchase of the car.

In some embodiments of the technology disclosed herein, the tracking pixel comprises a unique data element included in the email, such that when the purchaser opens the email and accesses the unique data element, the IP address associated with the purchaser is obtained by the server associated with the car seller. In some such embodiments, the tracking pixel comprises a hyperlink for unsubscribing from an email list, such that when the purchaser accesses the unsubscribe link, the IP address associated with the purchaser is obtained by the server associated with the car seller.

In some embodiments of the technology disclosed herein, the cookie ID of the car purchaser is obtained from a server associated with the car seller, based on the IP address of the car purchaser.

In some embodiments of the technology disclosed herein, retrieving an IP address comprises retrieving the IP address of the viewer of the at least one first car advertisement by searching a network for occurrences of IP addresses associated with the personal identifying information of the car purchaser. In some such embodiments, the retrieving comprises providing the personal identifying information of the car purchaser to a third party, and the third party carrying out the searching.

In some embodiments of the technology disclosed herein, retrieving cookie data comprises retrieving the cookie data of the viewer of the at least one second car advertisement by searching a network for occurrences of cookie IDs associated with the at least one of the personal identifying information of the car purchaser and the IP address of the car purchaser. In some such embodiments, the retrieving comprises providing at least one of the personal identifying information and the IP address of the car purchaser to a third party, and the third party carrying out the searching.

In some embodiments of the technology disclosed herein, the attempting also comprises retrieving an HTTP referrer field of an HTTP request for a web site associated with the car seller, the HTTP request originating at the IP address of the car purchaser, and extracting from the HTTP referrer field an identity of a website from which the purchaser arrived at the website associated with the car seller.

In some embodiments of the technology disclosed herein, the attempting also comprising correlating information obtained from the cookie ID of the car purchaser and from the retrieved cookie data based on an IP address of the car purchaser, thereby to enhance the determined advertisement viewing history of the car purchaser.

In accordance with another aspect of an embodiment of the technology disclosed herein, there is provided a method for tracking car sales by a car seller, the method comprising selling a car to a car purchaser and obtaining from the car purchaser personal identifying information, including at least an email address, sending an email to the car purchaser via a network node, using the email address as an identifier, wherein the email comprises data viewable only by downloading the data from a hardware server associated with the car seller, obtaining an electronic identifier of the car purchaser, the electronic identifier including at least one of an IP address and a cookie ID, after a purchase of the car, using the obtained electronic identifier, identifying data viewed by the purchaser of the car before the purchase thereof, the viewed data sent and received via a packet switched network comprising a plurality of hardware switches and hardware routers, and determining, based on the identified data viewed by the purchaser, an advertisement viewing history of the car purchaser and which advertisement ultimately led to purchase of the car.

In some embodiments of the technology disclosed herein, the obtaining an electronic identifier comprises including a tracking pixel in the email sent to the car purchaser, the tracking pixel comprising a unique data element included in the email, such that when the purchaser opens the email and accesses the unique data element, an IP address associated with the purchaser is obtained by the server associated with the car seller.

In some embodiments of the technology disclosed herein, the obtaining an electronic identifier comprises retrieving an IP address of a viewer of at least one first car advertisement, an identity of the viewer unknown to the car seller, by searching a network for occurrences of IP addresses associated with the personal identifying information of the car purchaser.

In some embodiments of the technology disclosed herein, the obtaining an electronic identifier comprises retrieving cookie data stored on a hardware storage device of at least one viewer of at least one second car advertisement, an identity of the viewer unknown to the car seller, by searching a network for occurrences of cookie IDs associated with the at least one of the personal identifying information of the car purchaser and the IP address of the car purchaser.

In some embodiments of the technology disclosed herein, the identifying data viewed by the purchaser comprises determining, based on matches of identifying data including at least one of email address, IP address, and cookie ID which advertisements were viewed by the car purchaser and storing the matches in a tangible storage medium.

In accordance with another aspect of an embodiment of the technology disclosed herein, there is provided a device for tracking car sales by a car seller, the device comprising a tangible storage medium storing personal identifying information obtained from a car purchaser following sale of a car to the car purchaser, the personal identifying information including at least an email address, a network node sending an email to the car buyer, using the email address as an identifier, wherein the email comprises data viewable only by downloading the data from a server associated with the car seller, and a hardware processor, attempting to identify data viewed by the purchaser of the car before the purchase thereof, the viewed data sent and received via a packet switched network comprising a plurality of hardware switches and hardware routers, the hardware processor including a data collecting module generating the email sent to the car purchaser and including a tracking pixel in the email, thereby to obtain at least one of an internet protocol (IP) address and cookie ID of the car purchaser, an onboarding module retrieving an IP address of a viewer of at least one first car advertisement, an identity of the viewer unknown to the car seller and retrieving cookie data stored on a hardware storage device of at least one viewer of at least one second car advertisement, an identity of the viewer unknown to the car seller, and an electronic identifier analysis module determining, based on matches of identifying data including at least one of email address, IP address, and cookie ID which advertisements were viewed by the car purchaser and storing the matches in a tangible storage medium and determining, based on the matched identifying data, an advertisement viewing history of the car buyer and which advertisement ultimately led to purchase of the car.

In some embodiments of the technology disclosed herein, the onboarding module retrieving the IP address of the viewer of the at least one first car advertisement and retrieving the cookie data of the viewer of the at least one second car advertisement by searching a network for occurrences of IP addresses associated with the personal identifying information of the car purchaser. In some such embodiments, the onboarding module provides the personal identifying information of the car purchaser to a third party, and the third party carrying out the searching.

### BRIEF DESCRIPTION OF THE DRAWINGS

FIG. 1 is a high level block diagram of a device for tracking car sales from a car seller according to an embodiment of the teachings herein.

FIGS. 2A and 2B, taken together, are a high level flow chart drawing of a method for tracking car sales from a car seller according to an embodiment of the teachings herein.

FIG. 3 shows a high level block diagram of a device that may be used to carry out the disclosed technology.

FIG. 4 shows a flow chart of an onboarding process for tracking car sales from a car seller according to an embodiment of the teachings herein.

A better understanding of the disclosed technology will be obtained from the following detailed description of the preferred embodiments taken in conjunction with the drawings and the attached claims.

### DETAILED DESCRIPTION

Embodiments of the disclosed technology comprise a method and device tracking car sales by a car seller. The method and device obtain personal identifying information of a car purchaser, including an email address of the purchaser, and send to the purchaser, via the email address, an email comprising data viewable only by downloading the data from a hardware server associated with the car seller. Using the downloaded data, or other methods, an electronic identifier of the car purchaser, such as an internet protocol (IP) address and/or a cookie ID, is obtained. Following purchase of the car, and using the obtained electronic identifier, data viewed by the purchaser before the purchase of the car is identified, and the identified data is used to determine an advertisement viewing history of the car purchaser, and which advertisement ultimately led to purchase of the car.

Referring now to the drawings, which represent a method and device for tracking car sales by a car seller, the description of same is as follows.

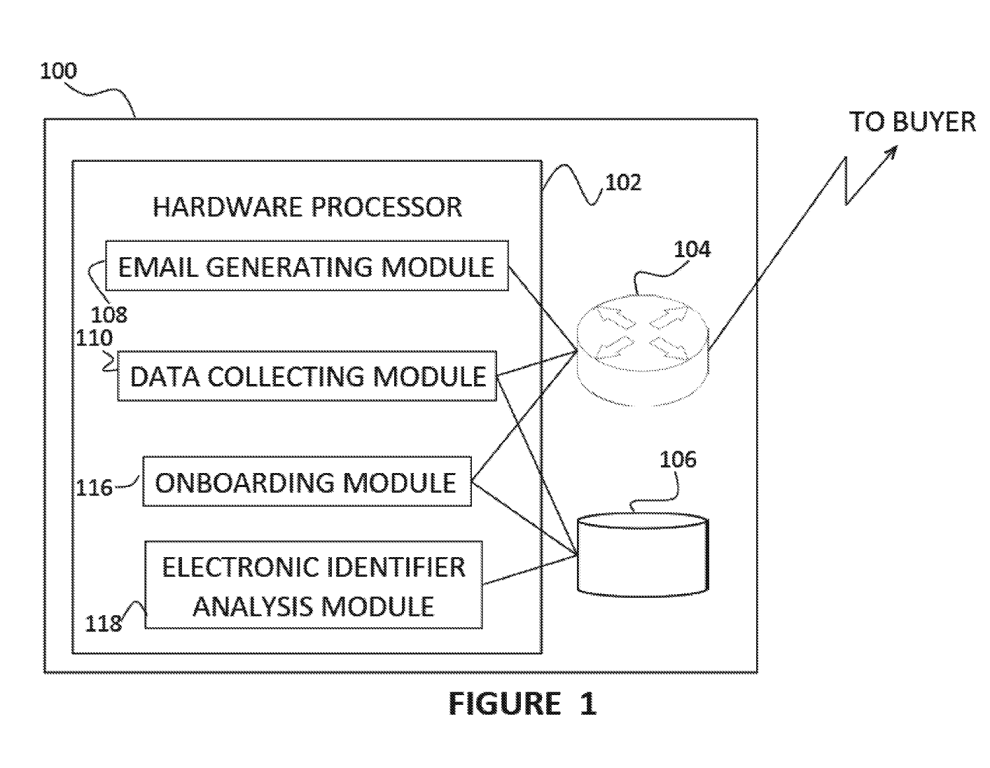

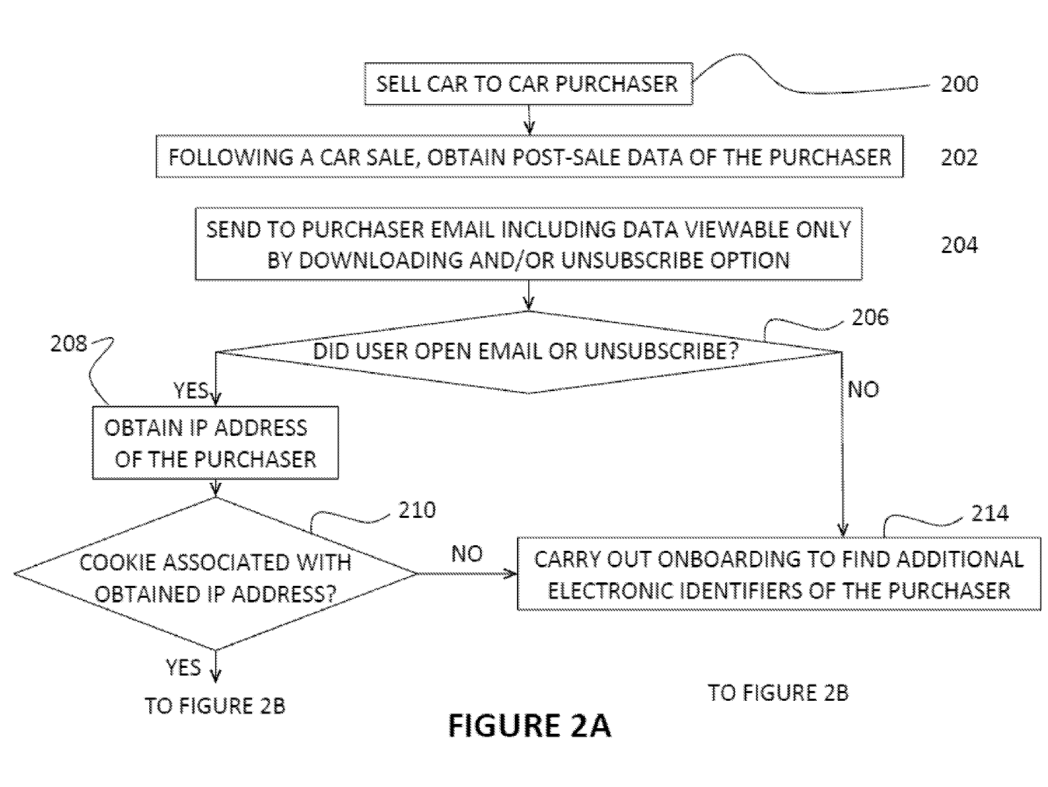

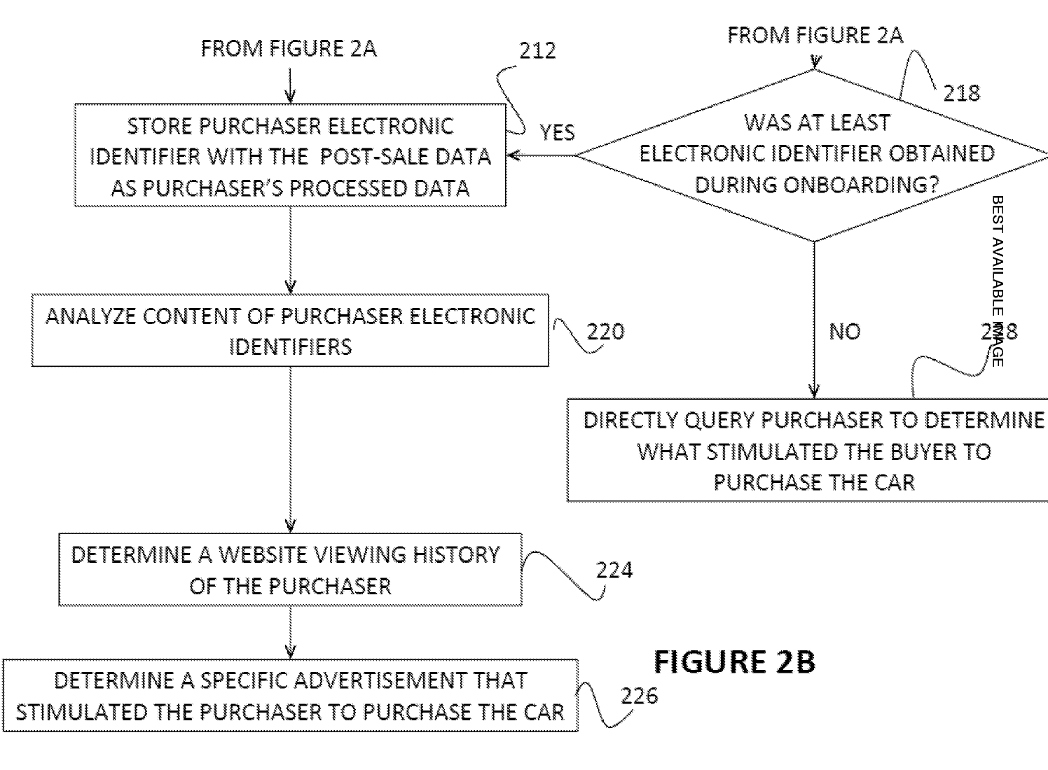

FIG. 1 is a high level block diagram of a device for tracking car sales by a car seller according to an embodiment of the teachings herein. FIGS. 2A and 2B, taken together, are a high level flow chart drawing of a method for tracking car sales from a car seller according to an embodiment of the teachings herein.

In FIG. 1, a device 100 for tracking car sales by a car seller includes a hardware processor 102, functionally associated with a network node, such as a packet switched router 104, and with a tangible storage medium, such as a database 106. In some embodiments, the packet switched router 104 forms part of a packet switched network comprising at least two hardware routers and at least one electrically coupled data connection between the two hardware routers. In the context of the present application the term “tangible storage medium” is defined as a hardware storage medium, such as a disk, hard-drive, or server, dedicated for storage of electronic data.

Following sale of a car to a car purchaser, as seen at step 200 of FIG. 2A, at step 202 of FIG. 2A the car seller obtains from the car purchaser post-sale identifiers of the purchaser, including at least an email address of the purchaser, and in some embodiments, also including additional identifiers of the purchaser such as a physical address, a telephone number, a social media profile identifier, and the like. In some embodiments, the post-sale identifiers of the car purchaser are stored by the device 100, for example in tangible storage medium 106. In the context of the present application the term “social media profile identifier” relates to any piece of information used to identify a user in a social media website or other venue, such as a user-name, an avatar, an alias, and the like.

As seen in FIG. 1, hardware processor 102 includes an email generating module 108, which generates an email to the car purchaser, the email including data, viewable only if the user opens the email and downloads the data from a server associated with said car seller, and/or an unsubscribe option. At step 204 of FIG. 2A, the email is sent to the car purchaser using the email address included in the post-sale identifiers of the purchaser, for example via packet switched router 104 and the network associated therewith. In some embodiments the data comprises a tracking pixel, although any suitable type of data may be included in the email sent to the car purchaser, such as files, images, or hyperlinks.

Specifically, a tracking pixel is included in an email sent to those subscribing to an email mailing list of the car dealer, place of car purchase, or company manufacturing or selling the car. When this pixel is downloaded by a viewer of an email, based on, for example, a unique uniform resource locator (URL) of each pixel, it is determined that a particular person associated with a particular email address is viewing the email. This person's IP address is now known and can be used to compare with previous website views for car purchases, and as such, is linked to a particular tracking cookie based on transitive reasoning. That is, once the person is linked to an IP address, and the IP address is linked to a cookie previously sent to a user, it is now known or reasonably assumed when the cookie was related to views of car websites or car advertisements, that the person viewing the email with tracking pixel is the same person who viewed the car advertisements. Further, as explained hereinbelow, the IP address of those viewing car advertisements is also known as it is transmitted to the server sending the ads. As such, a more direct correlation can be made between the car buyer with known email address and car website and advertisement views/downloads over a packet switched network via hardware routers and switches.

In the context of the present application, the term “IP address” or “internet protocol address” is defined as a unique identifier that identifies a specific computer for communication over a network, such as the Internet, and is associated with a protocol used for such communication. An IP address may include four three-digit numbers separated by periods, six three-digit numbers separated by periods, or may constitute any other identifier which uniquely identifies a computer within a network of computers.

At step 206 of FIG. 2A, if the car purchaser opened the email and/or unsubscribed from the email thereby activating the tracking pixel or accessing the server associated with the car seller to download data therefrom, at step 208 of FIG. 2A the IP address of the car purchaser is obtained.

At step 210 of FIG. 2A, a data collecting module 110 of hardware processor 102 queries tangible storage medium 106 to determine whether or not a cookie is associated with the obtained IP address. If one or more such cookies are found, the cookies and the obtained IP addressed, which in some cases are called the electronic identifiers of the purchaser, are associated with the purchaser's post-sale identifiers, and are stored in tangible storage medium 106 as the purchaser's processed data, at step 212 of FIG. 2B.

In the context of the present application, the term “cookie”, which is interchangeable with any of the terms “IITTP cookie”, “web cookie” and “browser cookie”, is defined as a small piece of data sent from a website and stored in a user's web browser while the user is browsing that website. Every time the user loads the website, the browser sends the cookie back to the server to notify the website of the user's previous activity.

Otherwise, if at step 210 of FIG. 2A the data collecting module 110 determines that no cookie is associated with the obtained IP address, or if at step 206 the purchaser does not open the email and does not unsubscribe from the email, at step 214 of FIG. 2A an onboarding module 116 forming part of hardware processor 102 attempts to find electronic identifiers for the car purchaser based on the post-sale identifiers and/or the obtained IP address of the purchaser.

In some embodiments, the onboarding module 116 provides the purchaser's post-sale identifiers and/or the obtained IP address to a third party, which third party searches the Internet or another network for occurrences of electronic identifiers, such as IP addresses and/or cookie IDs, associated with the purchaser's post sale identifiers and/or IP address provided by onboarding module 116. Any such found occurrences are provided by the third party to the onboarding module 116, for example via switched packet router 104, resulting in onboarding module 116 obtaining a pool of electronic identifiers, including IP addresses and/or cookie IDs, associated with the purchaser's post-sale identifiers and/or IP address.

At step 218 of FIG. 2B, if at least one electronic identifier of the purchaser, such as an IP address or cookie ID associated with the purchaser's post-sale identifiers or IP address, was obtained by onboarding module 116, the electronic identifiers obtained by the onboarding module 116 are associated with the purchaser's post-sale identifiers, and are stored in database 106 as the buyer's processed data, at step 214 of FIG. 2B.

At step 220 of FIG. 2B, an electronic identifier analysis module 118 of hardware processor 102 analyzes electronic identifiers included in the purchaser's processed data, based on the analysis and/or on matches of IP addresses, cookie IDs, and/or the email address of the purchaser, determines a website viewing history, or at least car (or more specifically, sites with content, including advertisements, related to the car purchased) by the purchaser at step 224 of FIG. 2B.

In some embodiments, the obtained cookie IDs relate to persistent cookies or to third-party cookies. Electronic identifier analysis module 118 analyzes these cookies as known in the art of HTTP cookies to obtain a browsing history of the purchaser, as explained hereinbelow.

Persistent cookies, also known as tracking cookies, are cookies that are planted by a server in a computing user's device, and outlast user sessions. Each time the user once again accesses the server, the cookie is sent back to the server, and may be updated and sent back to the user's device. As such, persistent cookies can be used to record vital pieces of information such as the user's browsing history or a browsing route a user used to initially come to a website.

Third party cookies are cookies that belong to a different domain than the one shown in the browser's address bar. For example, web pages can feature content from third party domains, such as banner ads, which can plant third party cookies. These cookies enable tracking the user's browsing history. For example, if the user visited multiple websites featuring content from the same third party domain, the third party cookie will list all the websites from which it was sent back to the third party server, thereby providing a browsing history of the user.

In some embodiments, the electronic identifier analysis module 118 may determine a specific advertising web site or server, or a specific form of digital advertising or web traffic which was seen by the car purchaser prior to purchasing the car functioned as the referrer and stimulated the purchaser to purchase the car, at step 226 of FIG. 2B. For example, if analysis of the electronic identifiers associated with the purchaser shows that the purchaser viewed an advertisement for the car seller in a first website on January 1 and viewed another advertisement for the car seller in a second website on March 1, and then purchased the car on March 3, the electronic identifier analysis module 118 may determine that the second website was the referrer which stimulated the purchaser to purchase the car from the car seller.

If no electronic identifiers corresponding to the purchaser's post sale identifiers is found at step 218 of FIG. 2B, at step 228 of FIG. 2B the purchaser may be directly queried what advertisement or other reference stimulated him to purchase the car from the car seller, for example by contacting the purchaser by email, telephone, or social media using the post-sale identifiers he provided.

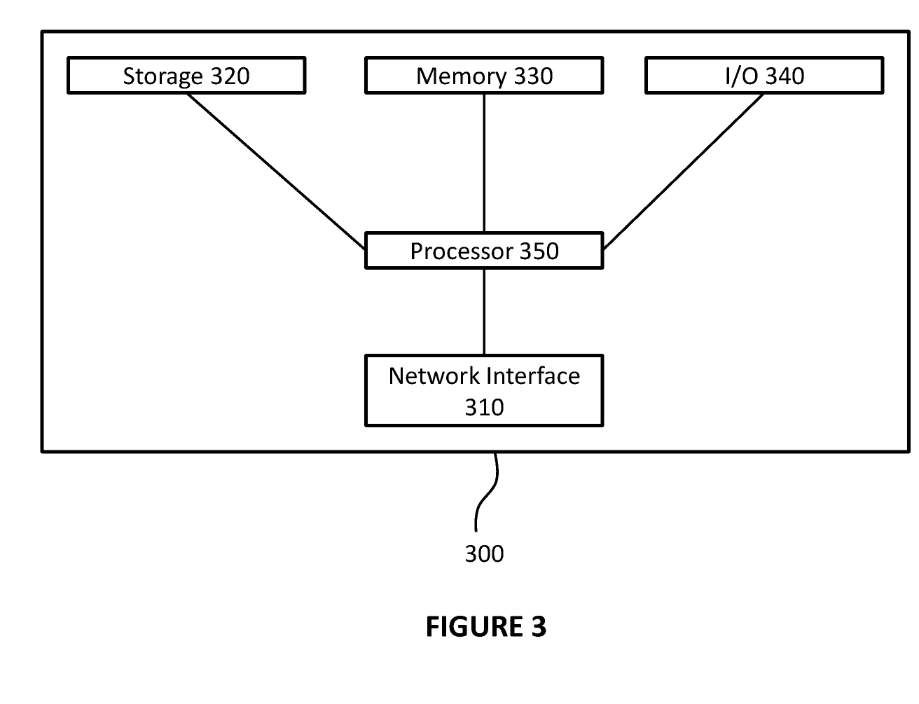

FIG. 3 shows a high-level block diagram of a device that may be used to carry out the disclosed technology. Device 300 comprises a processor 350 that controls the overall operation of the computer by executing the device's program instructions which define such operation. The device's program instructions may be stored in a storage device 320 (e.g., magnetic disk, database) and loaded into memory 330 when execution of the console's program instructions is desired. Thus, the device's operation will be defined by the device's program instructions stored in memory 330 and/or storage 320, and the console will be controlled by processor 350 executing the console's program instructions. A device 300 also includes one or a plurality of input network interfaces for communicating with other devices via a network (e.g., the internet). The device 300 further includes an electrical input interface. A device 300 also includes one or more output network interfaces 310 for communicating with other devices. Device 300 also includes input/output 340 representing devices which allow for user interaction with a computer (e.g., display, keyboard, mouse, speakers, buttons, etc.). One skilled in the art will recognize that an implementation of an actual device will contain other components as well, and that FIG. 3 is a high level representation of some of the components of such a device for illustrative purposes. It should also be understood by one skilled in the art that the method and devices depicted in FIGS. 1 and 2 may be implemented on a device such as is shown in FIG. 3.

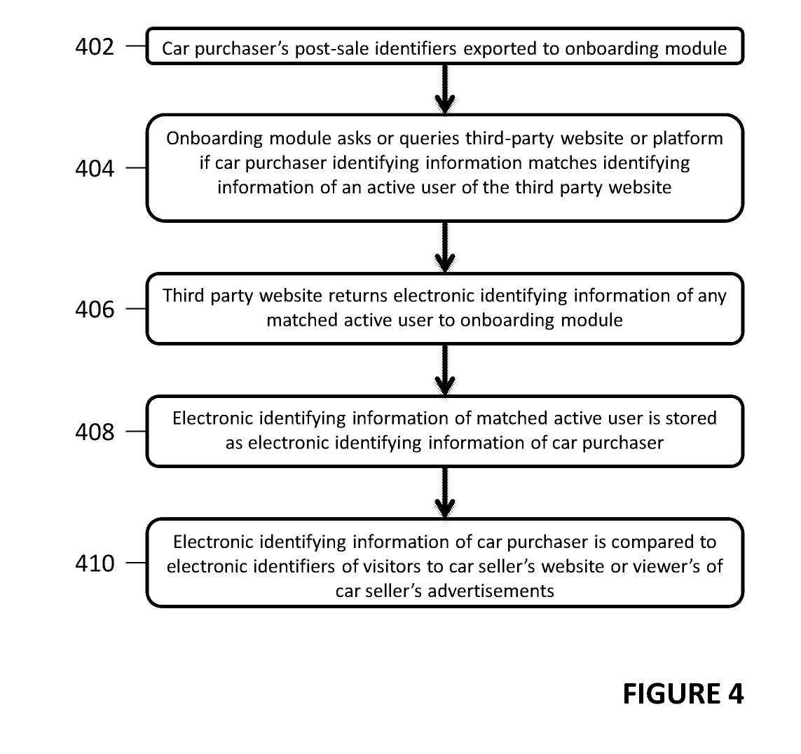

FIG. 4 may show more steps of the onboarding process described above in step 214 and step 218 of FIGS. 2A and 2B. At step 402, car purchaser identifying information in the form of a purchaser's post-sale identifiers is exported to the onboarding module. The onboarding module may be associated with a third party onboarder. At step 404, the onboarding module may ask or query a third party website or platform if the car purchaser identifying information matches identifying information assigned to an active user of the third party website. For example, if the car purchaser identifying information is an email address, the onboarding module may ask the third party website if this email address is associated with a log-in or other account information of an active user.

At step 406, if the third party website associates the car purchaser identifying information with an active user, the car purchaser is matched with the active user, and electronic identifying information of the active user is delivered to the onboarding module. The electronic identifying information of the active user may include, for example, an IP address, a cookie ID, and/or a device fingerprint assigned to the active user.

At step 408, the electronic identifying information of the active user is stored as the electronic identifying information of the car purchaser. At step 410, electronic identifying information now associated with the car purchaser is compared to electronic identifiers of visitors to the car seller's website or viewers of the car seller's advertisements which are stored by car seller. From this matching process, the advertisement viewing history or other activity of the car purchaser can be determined. This determination may assist a car seller in attributing the sale of the car to a particular referrer, referring source, advertisement or advertisements.

In some exemplary embodiments, post-sale identifiers of car purchasers may be exported to the onboarding module at a set time interval. For example, a car dealer list of post-sale identifiers for all car purchasers whom bought a car over a rolling period of 30, 60 or 90 days may be forwarded on an ongoing basis. In some exemplary embodiments, it may first be verified that no electronic identifiers stored by the car seller are already associated with the car purchaser before exporting that car purchaser's post sale identifiers to the onboarding module.

If no electronic identifying information of a car purchaser is obtained from a third party website or if no electronic identifying information of the purchaser is matched to an electronic identifier stored by the car seller, the car purchaser may be directly queried as to any referral or advertisement which influenced their purchase.

While the disclosed technology has been taught with specific reference to the above embodiments, a person having ordinary skill in the art will recognize that changes can be made in form and detail without departing from the spirit and the scope of the disclosed technology.

The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A method for tracking car sales by a car seller, comprising:
selling a car to a car purchaser and obtaining from said car purchaser personal identifying information, including at least an email address;
exporting said personal identifying information to an onboarding module;
matching said personal identifying information to identifying information assigned to an active user of at least one third party website;
obtaining electronic identifying information of said car purchaser from said at least one third party website, said electronic identifying information including at least one of an IP address, a cookie ID, and a device fingerprint assigned to said active user;
matching said electronic identifying information of said car purchaser to an electronic identifier stored by said car seller of a viewer of one or more car advertisements to determine an advertisement viewing history of said car purchaser.

2. The method of claim 1, further comprising:
attributing the sale of the car to one of the one or more car advertisements based on the advertisement viewing history of said car purchaser.

3. The method of claim 1, further comprising:
exporting at least one second car purchaser personal identifying information to said onboarding module simultaneously with said car purchaser personal identifying information.

4. The method of claim 1, further comprising:
exporting a plurality of car purchaser personal identifying information to said onboarding module at a set time interval.

5. The method of claim 1, wherein said onboarding module is a third party onboarder.

6. The method of claim 1, wherein said car dealer stores a plurality of electronic identifiers of viewers of one or more car advertisements.

7. The method of claim 1, wherein said car purchaser personal identifying information includes a street address.

8. The method of claim 1, further comprising:
verifying that no electronic identifiers stored by said car seller are associated with said car purchaser before exporting said personal identifying information to the onboarding module.

9. The method of claim 1, further comprising:
directly querying said car purchaser if no electronic identifying information of said car purchaser is obtained from said at least one third party website or if no electronic identifying information of said car purchaser is matched to an electronic identifier stored by said car seller.

10. A method for tracking car sales by a car seller, comprising:
selling a car to a car purchaser and obtaining from said car purchaser personal identifying information, including at least an email address;
sending an email to said car purchaser via a network node, using said email address as an identifier, wherein said email comprises data viewable only by downloading said data from a hardware server associated with said car seller, and an option to subscribe or unsubscribe to future email notifications;
receiving an indication if said email is opened and, if so, obtaining an electronic identifier of said car purchaser, said electronic identifier including at least one of an IP address and a cookie ID;
receiving an indication if said subscribe or unsubscribe option is elected and, if so, obtaining an electronic identifier of said car purchaser, said electronic identifier including at least one of an IP address and a cookie ID;
if no indication is received that said email is open and if no indication is received that said subscribe or unsubscribe option is elected, exporting said car purchaser personal identifying information to an onboarding module;
requesting an indication from at least one third party website if said car purchaser personal identifying information matches identifying information of an active user of said at least one third party website and, if so, obtaining an electronic identifier of said active user, said electronic identifier including at least one of an IP address and a cookie ID;
assigning said electronic identifier of said active user to said car purchaser; and
matching said electronic identifier of said car purchaser to an electronic identifier stored by said car seller of a viewer of at least one car advertisement to determine an advertisement viewing history of said car purchaser.

11. The method of claim 10, further comprising:
attributing the sale of the car to one of the one or more car advertisements based on the advertisement viewing history of said car purchaser.

12. The method of claim 10, further comprising:
exporting at least one second car purchaser personal identifying information to said onboarding module simultaneously with said car purchaser personal identifying information.

13. The method of claim 10, further comprising:
exporting a plurality of car purchaser personal identifying information to said onboarding module at a set time interval.

14. The method of claim 10, wherein said onboarding module is a third party onboarder.

15. The method of claim 10, wherein said car dealer stores a plurality of electronic identifiers of viewers of one or more car advertisements.

16. The method of claim 10, wherein said car purchaser personal identifying information includes a street address.

17. The method of claim 10, further comprising:
verifying that no electronic identifiers stored by said car seller are associated with said car purchaser before exporting said car purchaser personal identifying information to an onboarding module.

18. The method of claim 10, further comprising:
directly querying said car purchaser if no electronic identifying information of said car purchaser is obtained from said at least one third party website or if no electronic identifying information of said car purchaser is matched to an electronic identifier stored by said car seller.
